(19) United States
(12) Patent Application Publication
(10) Pub. No.: US 2015/0270879 A1
(43) Pub. Date: Sep. 24, 2015

(54) SYSTEM AND METHOD FOR EXPLICIT CHANNEL SOUNDING BETWEEN ACCESS POINTS

(71) Applicant: Magnolia Broadband Inc., Englewood, NJ (US)

(72) Inventors: Phil F. CHEN, Denville, NJ (US); Haim HAREL, New York, NY (US); Stuart S. JEFFERY, Los Altos, CA (US); Kenneth KLUDT, San Jose, CA (US)

(21) Appl. No.: 14/481,319

(22) Filed: Sep. 9, 2014

Related U.S. Application Data
(63) Continuation-in-part of application No. 14/449,431, filed on Aug. 1, 2014, now Pat. No. 9,100,154.
(60) Provisional application No. 61/955,433, filed on Mar. 19, 2014.
(60) Provisional application No. 61/955,433, filed on Mar. 19, 2014.
(60) Provisional application No. 61/982,569, filed on Apr. 22, 2014.

(51) Int. Cl. H04B 7/04; H04W 24/08

(52) U.S. Cl. CPC H04B 7/0417; H04W 24/08

(57) ABSTRACT

An access point (AP) and a method implemented in an AP for 802.11 AP to AP explicit channel state information (CSI) sounding so that inter AP interference can be reduced and multiple APs transmissions that can occur simultaneously on the same radio channel. An AP may be configured to monitor signals received by its radio circuitry from at least one associated STA and at least one co-channel AP and to send a message to said at least one associated STA and said at least one co-channel AP via the radio circuitry as part of a sounding sequence implemented by the baseband processor.

### CROSS REFERENCE TO RELATED APPLICATIONS

This application is a continuation-in-part of U.S. patent application Ser. No. 14/449,431 filed on Aug. 1, 2014, which claims the benefit of U.S. Provisional Application No. 61/955,433 filed on Mar. 19, 2014. This application also claims the benefit of U.S. Provisional Application No. 61/955,433 filed on Mar. 19, 2014 and U.S. Provisional Application No. 61/982,569 filed on Apr. 22, 2014. All of the above applications are incorporated herein by reference in their entirety.

### FIELD OF THE INVENTION

The present invention relates generally to the field of wireless communication, and more specifically to high efficiency Wi-Fi systems.

### BACKGROUND OF THE INVENTION

Prior to setting forth a short discussion of the related art, it may be helpful to set forth definitions of certain terms that will be used hereinafter. Many of these terms are defined in the Institute of Electrical and Electronics Engineers (IEEE) 802.11 specification but it should be appreciated that the invention is not limited to systems and methods complying with the IEEE 802.11 specification.

The term “Wi-Fi” is used to refer to technology that allows communication devices to interact wirelessly based on the Institute of Electrical and Electronics Engineers (IEEE) 802.11 standards. The wireless communication may use microwaves bands, e.g. in the 2.4 GHz and 5 GHz.

The term “AP” is an acronym for Access Point and is used herein to define a device that allows wireless devices (known as User Equipment or “UE”) to connect to a wired network using Wi-Fi, or related standards. The AP usually connects to a router (via a wired network) as a standalone device, but it can also be an integral component of the router itself.

The term “UE” is an acronym for User Equipment(s) and is an example of a station, e.g. Wi-Fi station (STA) that may attach to an AP.

The term “associated STA” as used herein refers to a STA that is served by a certain AP, for example with a certain Service Set Identifier (SSID).

The term “station” or STA is a term used for any participant on the network, for example as used in the 802.11 specification. Both UEs and APs are considered in this context to be examples of stations. In the following the abbreviation STA is used for stations whose packets are detected by a Wi-Fi RDN station implementing embodiments of the invention.

“Beacon transmission” refers to periodical information transmission which may include system information. This information may be included in what is termed a “beacon frame” or “beacon management frame”.

BSS is acronym for Basic Service Set, which is typically a cluster of Stations associated with an AP dedicated to managing the BSS. A BSS built around an AP is called an infrastructure BSS.

APSS is an acronym for AP Sounding Set. This is a cluster of APs implementing embodiments of the invention that work together with mutual sounding to reduce interference.

NDP is an acronym for null data packet.

NAV is an acronym for network allocation vector as defined in the 802.11 specification.

The specific Carrier Sense Multiple Access/Collision Avoidance (CSMA/CA) mechanism used in the 802.11 Media Access Control (MAC) is referred to as the distributed coordination function (DCF). A STA that wishes to transmit first performs a clear channel assessment (CCA) by sensing the medium for a fixed duration, the DCF inter-frame space (DIFS).

SIFS, Short Inter Frame Space, as defined in the 802.11 specifications is the period between reception of the data frame and transmission of the ACK. SIFS is shorter than DIFS.

The term “sounding” refers to a channel calibration procedure involving the sending of a message or packet, the packet being called a “sounding packet”, from one participant on a network to another. This may be part of a “sounding sequence” involving the exchange of messages, e.g. packets, for example as defined in the 802.11 specifications.

The term Clear Channel Assessment (CCA) as used herein refers to the CCA function as defined in the 802.11 specifications.

The acronym CSI stands for channel state information.

The term “MIMO” is an acronym for multiple input multiple output and as used herein, is defined as the use of multiple antennas at both the transmitter and receiver to improve communication performance. MIMO offers significant increases in data throughput and link range without additional bandwidth or increased transmit power. It achieves this goal by spreading the transmit power over the antennas to achieve spatial multiplexing that improves the spectral efficiency (more bits per second per Hz of bandwidth) or to achieve a diversity gain that improves the link reliability (reduced fading), or increased antenna directivity.

“Channel estimation” is used herein to refer to estimation of channel state information which describes properties of a communication link such as signal to noise ratio “SNR” and signal to interference plus noise ratio “SINR”. Channel estimation may be performed by user equipment or APs as well as other components operating in a communications system.

The term “beamforming” sometimes referred to as “spatial filtering” as used herein, is a signal processing technique used in antenna arrays for directional signal transmission or reception. This is achieved by combining elements in the array in such a way that signals at particular angles experience constructive interference while others experience destructive interference. Beamforming can be used at both the transmitting and receiving ends in order to achieve spatial selectivity. The operation of attempting to achieve destructive interference in order to cancel a signal in a particular direction or angle is referred to as “nulling”. Complete cancellation of a signal is not usually achieved in practice and a “null” in a radiation pattern may refer to a minimum in signal strength. The lower the signal strength, the “deeper” the null is said to be. When used herein, “radiation” typically refers to radio frequency radiation.

The term “beamformer” as used herein refers to analog and/or digital circuitry that implements beamforming and may include combiners and phase shifters or delays and in some cases amplifiers and/or attenuators to adjust the weights of signals to or from each antenna in an antenna array. Digital beamformers may be implemented in digital circuitry such as a digital signal processor (DSP), field-programmable gate array (FPGA), microprocessor or the central processing unit “CPU” of a computer to set the weights as may be expressed by phases and/or amplitudes of the above signals. Various techniques are used to implement beamforming including, for example, Butler matrices, Blass Matrices and Rotman Lenses. In general, most approaches may attempt to provide simultaneous coverage within a sector using multiple beams.

### SUMMARY

Wi-Fi is a time division duplex system (TDD), where the transmitting and receiving functions use the same channel, implemented with a limited amount of frequency resources that use techniques of collision avoidance (CSMA/CA) to allow multiple stations, user equipments (UEs) and APs to share the same channel.

In many deployments APs on the same radio channel are within CCA range of each other. Thus an AP maybe blocked from transmitting to its client STA (typically a UE) due to activity of a nearby or neighboring AP.

Multi-User MIMO (MU_MIMO) capable APs can develop complex antenna patterns that support simultaneous enhancing and nulling in specific directions. Nulling may be set toward a co-channel AP with the combined effect of reducing interference to the co-channel AP and reducing interference from this co-channel AP. The quality of this null is dependent on the channel state information (CSI) between the AP and the co-channel AP.

An AP equipped with beamforming can both enhance its signal to its client STA while simultaneously nulling its signal toward an interfering AP, for example using CSI on the paths to the client STA and the interfering AP. CSI can be derived for example by implicit or explicit feedback. However it is not provided as part of the over-the-air (OTA) standard for APs to communicate with each other.

The use of the term “implicit” or “implicitly” in this context refers to a process used for TDD protocols such as Wi-Fi, where both down and up links share the same spectrum. In the aforementioned process, the uplink channel estimated by an AP is assumed to be identical to the downlink one, based on the reciprocity principle. Therefore, in an example of this process, the channel from an STA towards an AP is considered by the AP to represent the channel from the AP towards the STA. Conversely, the use of the term “explicit” or “explicitly” in this context refers to a procedure where CSI is fed back. In an example of an explicit process between AP and STA, AP transmissions are channel estimated by the STA, and then fed back to the AP, providing the AP with, for example, the magnitude of phase and amplitude differences between the signals as transmitted by the AP vis-à-vis as received by the client/STA. Such information may allow the AP to gauge possible distortions in signals and correct them.

Explicit feedback is more accurate, and therefore more useful for generating a high quality null by an AP toward a STA or an AP. However a high quality, or “deep” null is not always required.

According to some embodiments of the invention, explicit CSI measurement between compatible APs is enabled so that inter AP interference can be reduced.

According to other embodiments of the invention a new procedure is developed that enables AP to establish an APSS (AP Sounding Set) with nearby compatible APs. An AP may then be able to selectively sound another AP using a modified 801.11ac sounding protocol. An APSS sounding set may include two or more APs.

According to some embodiments of the invention, an AP is provided that is configured to exchange messages with at least one associated station (STA) via a wireless channel. Thus the AP may comprise a plurality of antennas; radio circuitry configured to transmit and receive signals via said antennas; and a baseband processor. The baseband processor may be configured to monitor signals received by the radio circuitry from said at least one associated STA and at least one co-channel AP and to send a message to said at least one associated STA and said at least one co-channel AP via the radio circuitry as part of a sounding sequence implemented by the baseband processor.

The at least one co-channel AP may be located within a CCA range of the AP.

The sounding sequence may comprise for example an announcement message transmitted from the AP followed by messages transmitted from the AP. The announcement message and following message may be addressed respectively to said at least one associated STA and said at least one co-channel AP. The addressed messages may comprise a NDP announcement or a polling message transmitted after a NDP. The sounding sequence may be conducted according to the 802.11 standard, with a modification such that a message that would be intended for a STA, such as a UE, according to the standard, is instead addressed to the at least one AP.

Some embodiments of this invention include a method whereby an AP may obtain explicit feedback from a co-channel AP as an extension of the standard procedure of obtaining CSI information from its supported UE. In this manner the AP will have timely CSI information based on explicit feedback from the co-channel AP, enabling it to develop a high quality, or deep, null toward that AP.

According to other embodiments of the invention an AP may dynamically adjust the sounding rate, the sounding data quality and the specific STA towards which sounding is directed, for example based on changes in environment.

Embodiments of the invention comprise a method implemented in an AP configured to exchange messages with at least one associated STA via a wireless channel, the AP comprising: a plurality of antennas, radio circuitry configured to transmit and receive via said antennas, and a baseband processor. An example method may include monitoring signals received by the radio circuitry from said at least one associated STA and at least one co-channel AP; and sending a sounding message to said at least one associated STA and said at least one co-channel AP via the radio circuitry as part of a sounding sequence implemented by the baseband processor. The AP may then receive CSI from said at least one co-channel AP in response to said message.

According to other embodiments of the invention when an AP has data to send to an associated UE and finds that its own CCA has been set by one or more other APs that are part of its APSS, then it determines whether the quality of the CSI data that it possess will enable it to generate a pattern, or modify its current pattern, to reduce radiation to and from the one or more other APs. This pattern may have nulls sufficient to reduce AP's transmission toward another concurrently operating AP so as not to interfere with its activities and be able to deliver an acceptable signal to UE. If AP can meet these criteria, it may proceed to send data to UE. According to embodiments of the invention, an AP may determine this before modifying its current radiation pattern.

As stated above, an AP may determine if the CSI data it has at a particular moment is of sufficient quality. An AP's analysis may consider any of (a) how many milliseconds have elapsed since the last CSI update it received, (b) the stability of the CSI data—how rapidly is it changing and (c) the absolute quality of the CSI data versus what is required for nulling depth.

An AP may be modified, for example by installation of suitable software in its baseband processor, to respond to a message addressed to it from another AP. Thus embodiments of the invention also comprise an AP of which the baseband processor is configured to detect a sounding packet addressed to it sent by a co-channel AP over the wireless channel, and to send channel state information (CSI) to said at least one co-channel AP via the wireless channel, for example in response to a sounding packet. Such an AP may also have the capability to send sounding messages to other co-channel APs and receive CSI from them.

An AP may be configured to indicate that it is capable of responding to sounding packets from another AP, for example by transmitting an identification of this capability, for example in a beacon management frame.

### BRIEF DESCRIPTION OF THE DRAWINGS

For a better understanding of the invention, and in order to show how it may be implemented, references are made, purely by way of example, to the accompanying drawings in which like numerals designate corresponding elements or sections.

FIG. 1A shows a typical operational environment with multiple APs in CCA range according to embodiments of the invention;

FIG. 1B is a block diagram illustrating an access point with transmit and receive MIMO capability according to embodiments of the invention;

FIG. 2 illustrates how an AP equipped with beamforming can null its signal toward the interfering AP while transmitting to its client STA (a UE) in a typical operational environment with multiple APs in CCA range according to embodiments of the invention;

FIG. 3 shows a high level flow chart of the initialization phase of an AP according to embodiments of the invention;

FIG. 4A shows an example of an 802.11ac MU-MIMO sounding message flow according to embodiments of the invention;

FIG. 4B illustrates an example of APSS message flow using a modified 802.11ac MU-MIMO sounding procedure and modified messages according to embodiments of the invention;

FIG. 5 shows an example of an APSS NDP announcement message according to embodiments of the invention;

FIG. 6 illustrates an example of an APSS NDP message according to embodiments of the invention;

FIG. 7 illustrates an example of an APSS CSI feedback message according to embodiments of the invention;

FIG. 8 illustrates durations of each APSS sounding message type and several examples of APSS sounding message flow according to embodiments of the invention;

FIG. 9 shows an example of APSS sounding rate based on a maximum sounding overhead according to embodiments of the invention;

FIG. 10A illustrates an example of details a process of a beamformer AP adjusting APSS sounding and CSI upload rate according to embodiments of the invention;

FIG. 10B is a diagram showing successive CSI uploads for two different APs using the same upload rate according to embodiments of the invention;

FIG. 10C is a diagram showing successive CSI uploads for two different APs using different upload rates according to embodiments of the invention;

FIG. 11 illustrates a flow chart of an AP receiving APSS sounding messages and sending CSI feedback message according to embodiments of the invention;

FIG. 12 illustrates a flow chart of a beamformer AP determining to ignore the NAV set by another AP and proceed to send data to a UE, or to wait for channel is clear according to embodiments of the invention;

FIG. 13 shows an example of adding an AP's CSI feedback to 802.11ac MU-MIMO sounding protocol according to embodiments of the invention; and

FIG. 14 illustrates an example of modified 802.11ac NDP announcement message for APSS sounding according to embodiments of the invention.

FIG. 15 shows the structure of the frame used in a beacon transmission, where backhaul CSI feedback capability is indicated in the optional vendor specific portion of the frame in accordance with some embodiments of the present invention.

The drawings together with the following detailed description are designed make the embodiments of the invention apparent to those skilled in the art.

### DETAILED DESCRIPTION

It is stressed that the particulars shown are for the purpose of example and solely for discussing the preferred embodiments of the present invention, and are presented in the cause of providing what is believed to be the most useful and readily understood description of the principles and conceptual aspects of the invention. In this regard, no attempt is made to show structural details of the invention in more detail than is necessary for a fundamental understanding of the invention. The description taken with the drawings makes apparent to those skilled in the art how the several forms of the invention may be embodied in practice.

The invention is not limited in its application to the details of construction and the arrangement of the components set forth in the following descriptions or illustrated in the drawings. The invention is applicable to other embodiments and may be practiced or carried out in various ways. Also, it is to be understood that the phraseology and terminology employed herein is for the purpose of description and should not be regarded as limiting.

In description that follows, APs are assumed to operate in 40 MHz band with 4 antenna and use 400 nanosecond inter-symbol spacing. The ideas described can be adjusted for other bandwidths and other AP antenna configurations. An asterisk for example as in “AP*” is used to indicate that an AP is compatible with APSS, meaning for example that it is equipped with special software so that it can participate in an APSS, for example as a sounder or as a responder. AP*_1 is the AP that initiates the establishment of an APSS, for example by the sending of an invite message. If more than two AP*s are present, then multiple APSS sets may exist. APSS_ID is a 12 bit random code selected by AP*_1 to identify the APSS that it has created. AP*_i, where I {2 . . . n} is the designator for the different AP*s that are members of the APSS_ID.

Embodiments of the invention use a modified 802.11ac Null Packet Protocol procedure to establish an APSS network and to send sounding to compatible APs. AP*_1 may poll other APs, AP*_i, for example in a prioritized manner, to obtain CSI feedback. AP*_1 may adjust its CSI compression parameters, polling rate and polling sequence for each AP*_i based on specific stability of radio channel and maximum allowable APSS polling overhead. AP*_1 builds a table of most current CSI values for each AP*_i that has been sounded. When AP*_1 has data to send to UE_1 and finds one or more AP*_i has triggered CCA, AP*_1 determines whether an antenna pattern can be created that will null one or more concurrent AP*_i so that AP*_1 radiation toward AP*_i is below the CCA limit, for example a dB threshold, and create acceptable beam toward UE_1. If such a pattern can be created, AP*_1 creates the pattern and proceeds to send data to UE_1.

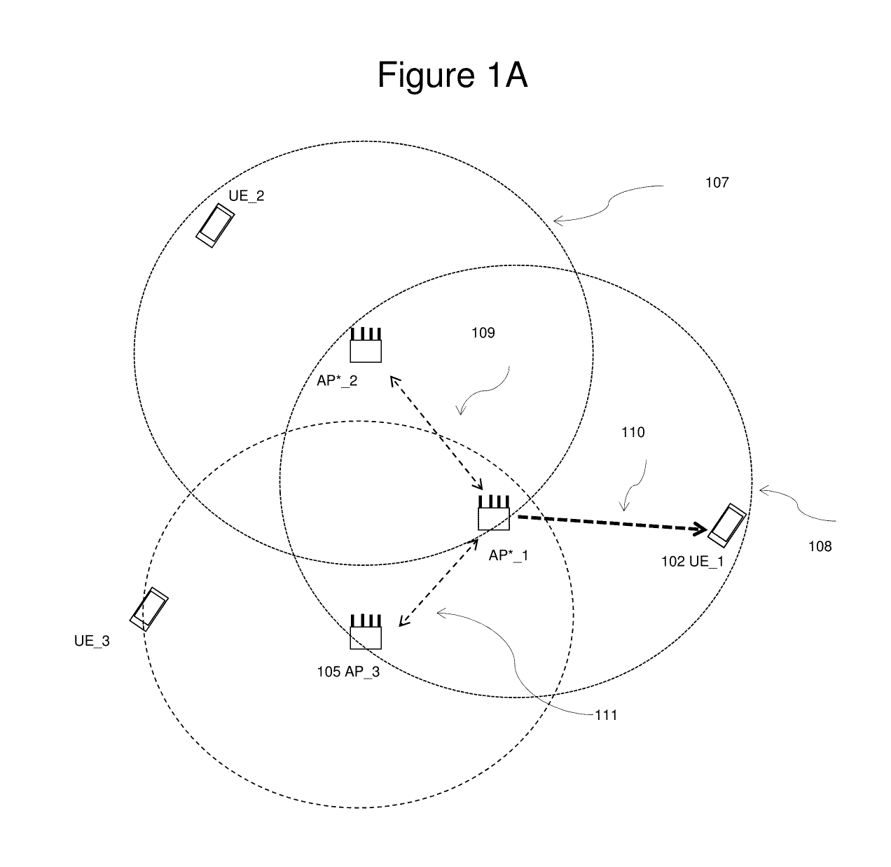

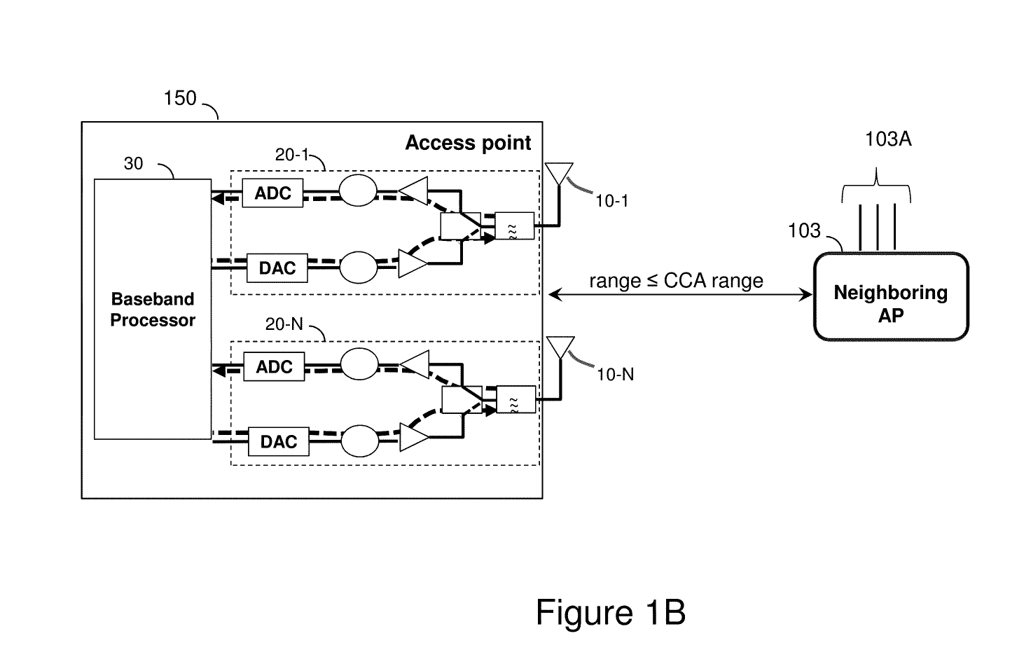

FIG. 1A shows an example basic operating environment in which embodiments of the invention may be implemented, with multiple neighboring APs in CCA range of each other. Other or different equipment and configurations may be used. AP*_i is an AP that has the capability to implement embodiments of the invention, which may be implemented in the form of a software enhancement, for example executed in the baseband processor of AP*_i. AP*_1 is going to send MU_MIMO data to UE_1, via path 110 and will sound UE_1 prior to sending data to UE_1 over-the-air, e.g. via a wireless channel. If AP*_2 is considered by AP*_1 to be a good candidate to null, determined by relative signal levels, geometry, etc. AP*_1 will start the sounding procedure via path 109 when its NAV is not set, meaning all the APs in CCA range are not active.

Also shown in FIG. 1A is UE_2 associated with AP*_2 and further AP*_3 with associated UE_3. The radiation pattern of AP*_1 is indicated by circle 108. This is intended to indicate an ideal pattern, not typically achieved in practice, in which the radiation from AP*_1 is uniform in all directions. Similarly the radiation patter of AP*_2 is indicated by circle 107. If AP*_3 is considered by AP*_1 to be a good candidate to null, AP*_1 will start a sounding procedure via path 111 with AP*_3.

FIG. 1B is a block diagram illustrating an AP 150 within CCA range of a neighboring AP 103, in accordance with some embodiments of the present invention. AP 150 may include for example a plurality of antennas 10-1 to 10-N, a plurality of radio circuitries 20-1 to 20-N configured to transmit and receive signals via a plurality of antennas 10-1 to 10-N in compliance with the IEEE 802.11 standard, and a baseband processor 30. AP 150 may be configured to transmit and receive signals within a clear channel assessment (CCA) range of neighboring AP 103 which has a plurality of antennas and may be configured to transmit and receive signals in a co-channel shared with AP 150 in compliance with the IEEE 802.11 standard.

Baseband processor 30 may be configured to monitor signals received by the radio circuitries 20-1 to 20-N and generate a set or list of neighboring co-channel APs, e.g. APs operating on the same frequency wireless channel, that each has plurality of antennas and are further located within a clear channel assessment (CCA) range of the AP. Baseband processor 30 may be further configured to instruct radio circuitries 20-1 to 20-N to transmit a sounding sequence to the list of neighboring access points, and receive Channel State Information (CSI) therefrom. A sounding sequence may comprise a sequence of control frames sent to beamformees and data frames indicative of the channel received from the beamformee.

Equipment such as an AP or components such as a baseband processor or radio circuitries may be configured to carry out embodiments of the present invention by for example including hard-wired circuitry and/or by executing code or software, or other methods.

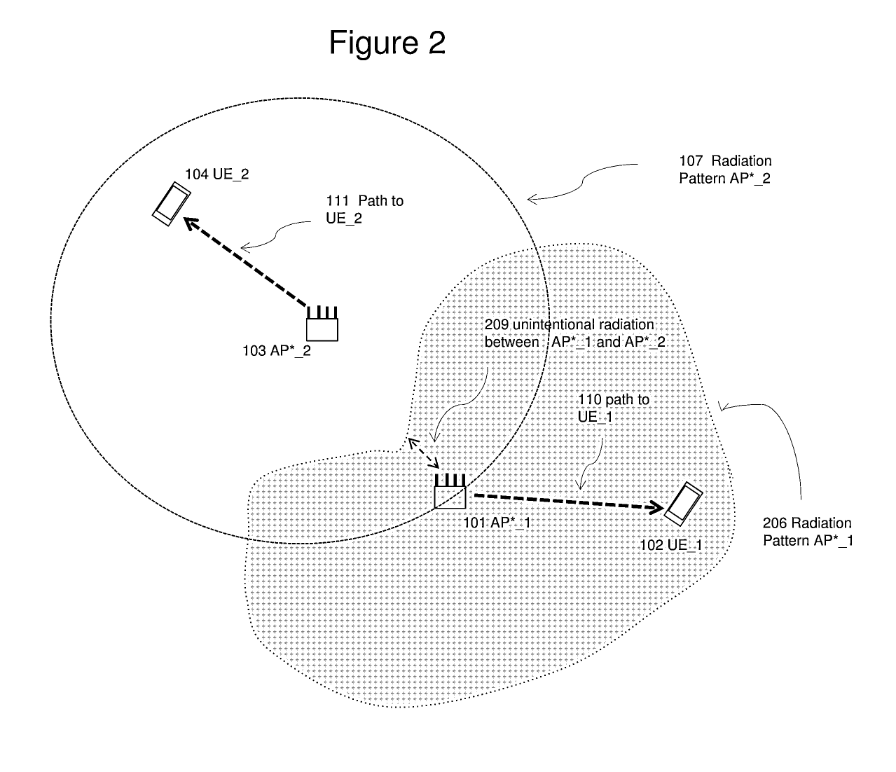

Referring back to FIG. 1A, embodiments of the invention propose a modification to the addressing approach used by AP*_1 according to the current 802.11 protocol when it sends the NDP announcement message. The NDP announcement message is broadcast and includes the address of a STA as well as an identifier for associated STAs that may then be polled individually using messages addressed specifically to those STAs. According to embodiments of the invention, AP*_1 may substitute AP*_2 in the receive address field usually used for an associated STA. Otherwise, the NDP announcement may be the same as that defined in the 802.11 protocol. For example an AP may send a message to at least one associated STA and at least one co-channel AP via its radio circuitry as part of a sounding sequence implemented by the baseband processor. Consequently, the various STAs will see the message flows as standard. AP*_1 may receive CSI from AP*_2 and each of its intended UEs that it polls (standard MU_MIMO sounding procedure), and AP*_1 may generate a pattern as shown in FIG. 2.

FIG. 2 illustrates how an AP equipped with beamforming, AP*_1, can both enhance its signal to its client STA, UE_1 102, while simultaneously nulling its signal toward an interfering AP*_2. This may be achieved using CSI on the path 209 between AP*_1 and AP*_2 and path 110 between AP*_1 and UE_1. CSI can be developed by for example implicit or explicit feedback as noted above.

FIG. 2 illustrates schematically that the modification of the radiation pattern results in a reduction of unwanted or unintentional radiation between the two APs, as indicated by path 209 which is reduced as compared to path 109 in FIG. 1. At the same, time the radiation between AP*_1 and UE_1 along path 110 may be enhanced as indicated by the extension of the radiation pattern 206 around UE_1.

According to embodiments of the invention, this may be achieved in an AP by the baseband processor being configured to set weights, e.g. values of amplitude and phase for respective antennas, to modify the spatial signatures or radiation patterns. The result may be such that spatial signatures are generated in both downlink and uplink to reduce interferences between a Wi-Fi AP and at least one of the N neighboring APs in APSS based on received CSI feedback from sounding. A data packet may then be sent or transmitted to a station (STA), or a group of stations (STAs).

According to embodiments of the invention AP*_1 is able to recognize nearby APs that are AP* compatible and to support communication between them. AP* capability can be added in as an information element in the beacon transmission.

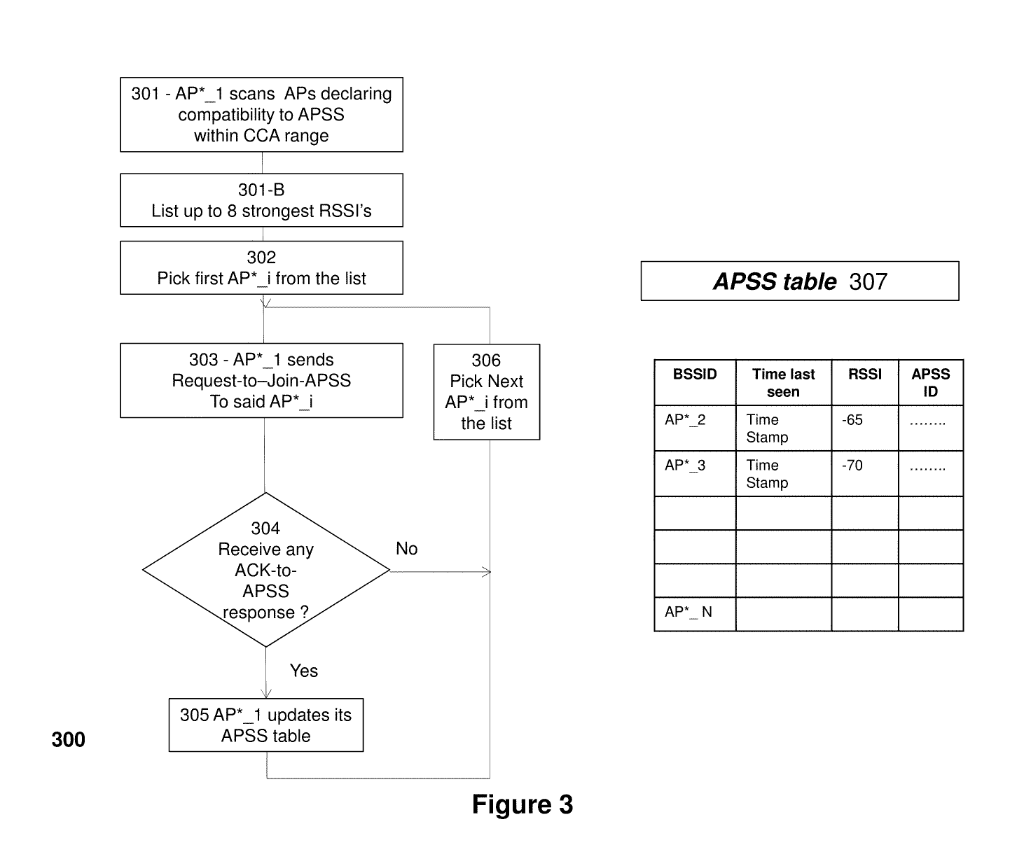

FIG. 3 illustrates shows a high level logic flow of a possible initialization phase of establishing an AP sounding set (APSS) according to embodiments of the invention. In operation 301, which may correspond to a software logic block, AP*_1 monitors or scans signals received by the radio circuitry 20-1-20-N from at least one associated STA, such as UE_1 and at least one other AP. AP*_1 may create or build a list of all AP*s that it can detect, noting BSSID, RSSI, SSID. As part of operation 301, this information is stored and continuously updated, for example in the form of Table 307 or other data structure, stored at AP*_1. For each intercept or AP response received, a time stamp is stored, as indicated by the second column in table 307. Compatible APs (AP*) may include a compatibility flag in their beacon management frame transmitted periodically. According to optional operation 301-B, the table 307 may be restricted to APs having the strongest RSSI, up to 8 APs in the non-limiting example of FIG. 3. According to embodiments of the invention, AP*s that are within CCA range of each other may establish an APSS network. This APSS network may be established by the initiating, or “anchor” AP*_1 registering all neighboring APs and inviting them to join the AP*_1's APSS network, at operation 303. This may be accomplished by AP*_1 registering with AP*_i and exchanging a new message, for example that is not part of the current standard. AP*_i will be aware that AP*_1 will do this because AP*_i will have seen AP*_1's beacon flag. In operation 304, AP*_1 may check whether AP*_i has respond to the invite or “Request-to-join” message. When AP*_i responds to the invite message, the flow proceeds to operation 305 where AP*_1 will update AP*_i's entries in Table 307. The sending of an invitation may be repeated for other AP*s in the list by the flow returning to operation 303. If an AP* that has been sent an invite message does not respond, operation 305 is bypassed and the flow returns to operation 303.

Although the above is described from the perspective of AP*_1, every AP*_i may form its own network. For example, if there are 3 AP*s surrounding AP*_1, then AP*_1 may build its network, but may also be a member of 3 other AP*s' networks. And as will be seen, AP*_1 will sound those 3 other AP*s (AP*_2, AP*_3 and AP*_4) but each of them may be sounding AP*_1 back. In this context a “network” of APs comprises an “anchor” or initiator AP* and one or more other AP*s that have established a communication path with the anchor AP, for example so that messages can flow in both directions between the anchor AP and the one or more other AP*s.

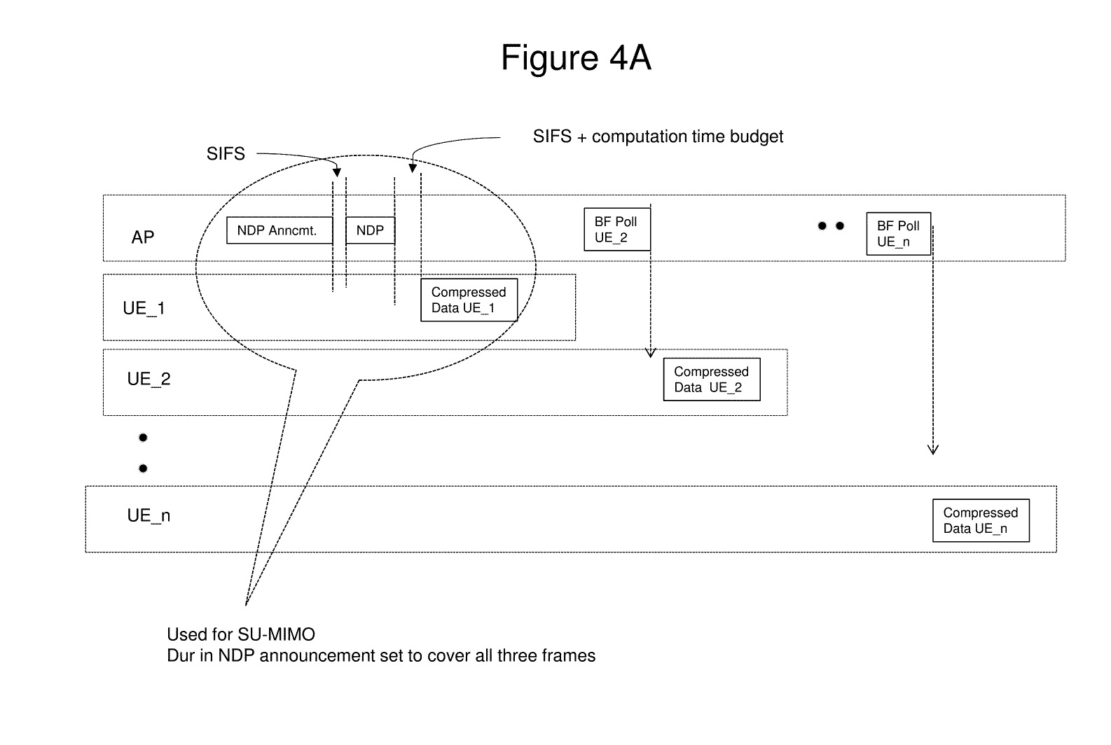

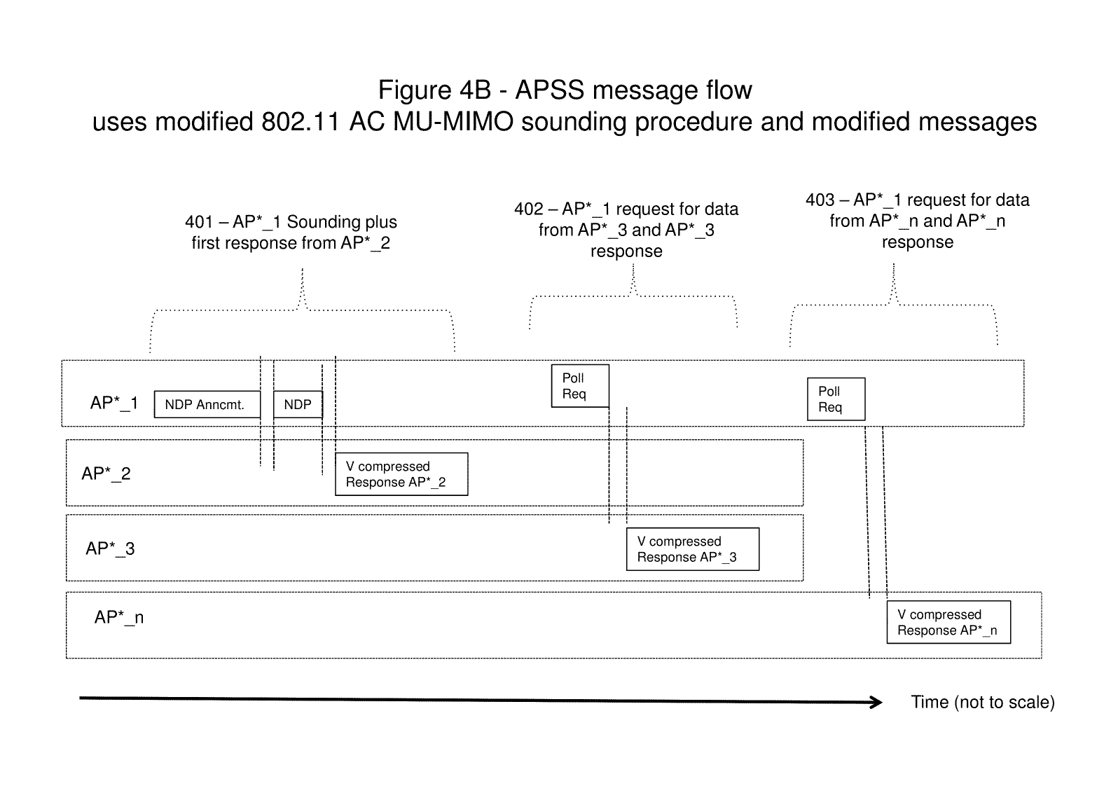

FIG. 4A shows by way of example a standard 802.11ac MU-MIMO protocol sounding message flow. An AP transmits or sends an NDP announcement, abbreviated in the figure to “NDP Anncmt”, followed by a NDP. The STA that was addressed in the receive field of the NDP announcement is expected to respond with compressed CSI information, shown as Compressed Data UE_1, which may be for example V compressed data as is known in the standard. After that, the AP polls the “other” STAs one by one. The “other” STAs know they might be polled as they are part of the association identifier (ID) “AID” list in the NDP announcement message (as will be discussed in FIG. 4B). Thus FIG. 4A shows a beamforming (BF) AP polling UE_2 followed by a response with compressed data from UE_2 and so on to UE_n. It should be noted that the duration, abbreviated to “Dur” is set in the NDP announcement to cover all three frames, NDP announcement, NDP and compressed data response.

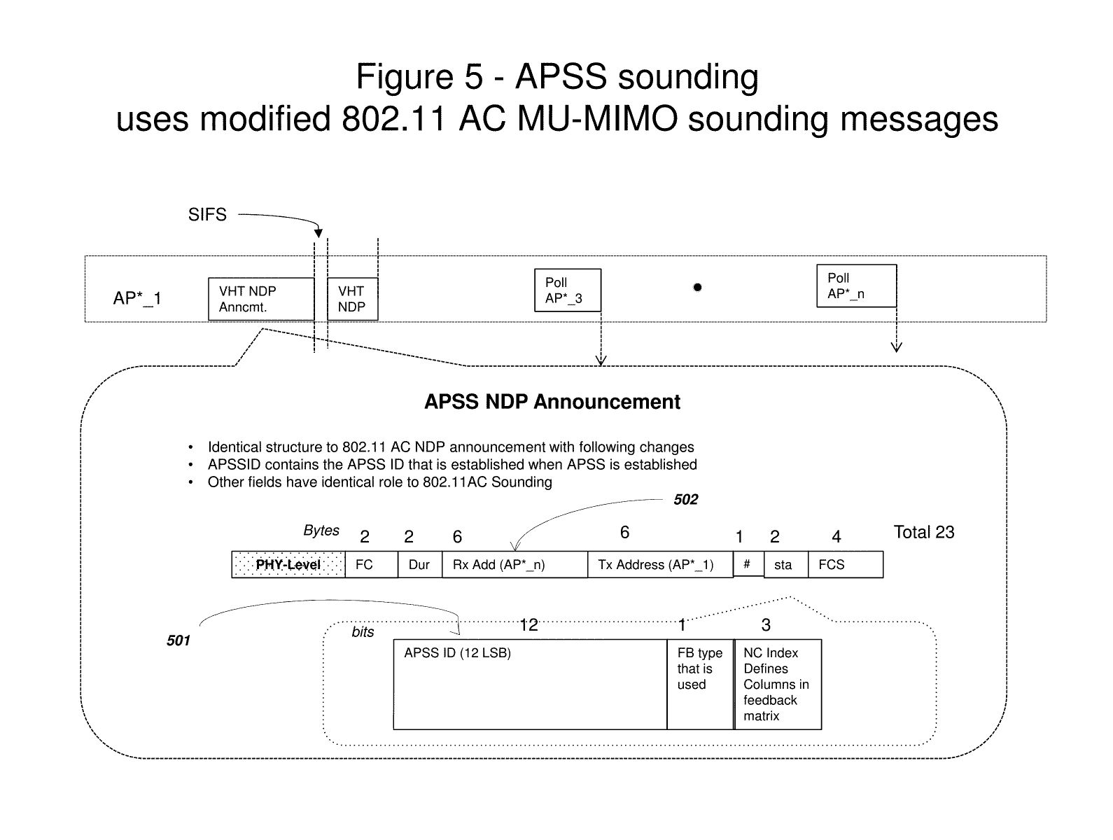

FIG. 4B shows an overall sounding procedure according to some embodiments of the invention, which is a variation of the 802.11ac procedure. At stage 401, when the channel is clear, AP*_1 sends an NDP announcement, followed by a SIFS gap, followed by the actual NDP frame. It then receives compressed data in response, for example V compressed Matrix feedback from addressed AP*_2. At stage 402, when the channel is again available, AP*_1 sends a poll request to AP*_3 and receives V compressed Matrix feedback from AP*_2. Similarly all AP*_n that are being monitored are polled as indicated at stage 403 where AP*_1 continues to poll the other AP*_n to collect the desired data. Four messages, APSS NDP Announcement, NDP, POLL and CSI response feedback, are involved in the sounding/feedback procedure. Examples of these messages suitable for embodiments of the invention are shown in more detail in FIGS. 5, 6 and 7.

FIG. 5 shows an APSS NDP announcement message which is identical to the 802.11ac NDP announcement message except that the first 12 bits in the STA field shown in the lower part of FIG. 5 are used to indicate the APSS ID 501 instead of the Association identity (ID) (AID) used when polling UEs. The value for these first twelve bits may be assigned by AP*_1 when the APSS is established. This value has the same function as the AID, but it creates an AP Sounding Set instead of creating UE Associations. The address field 502 in the VHT-NDP announcement is the BSSID of the AP*_n that is part of the APSS that AP*_1 has established. The NDP announcement frame is 23 Bytes long and sent at modulation coding scheme zero (MCS0) to assure all AP*s' detection of the message. Other coding schemes may be used according to embodiments of the invention. With PHY header, the message duration is 60 μsec (54 μsec for 400 nanosecond inter-symbol guard band) as per the standard.

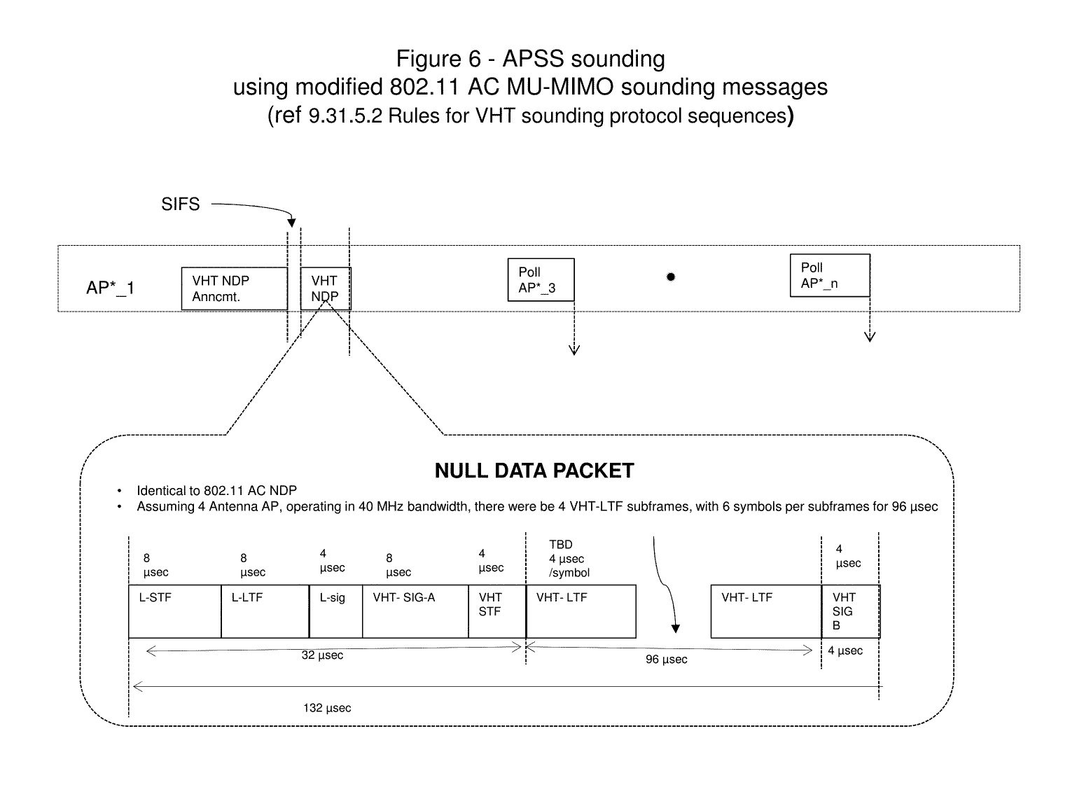

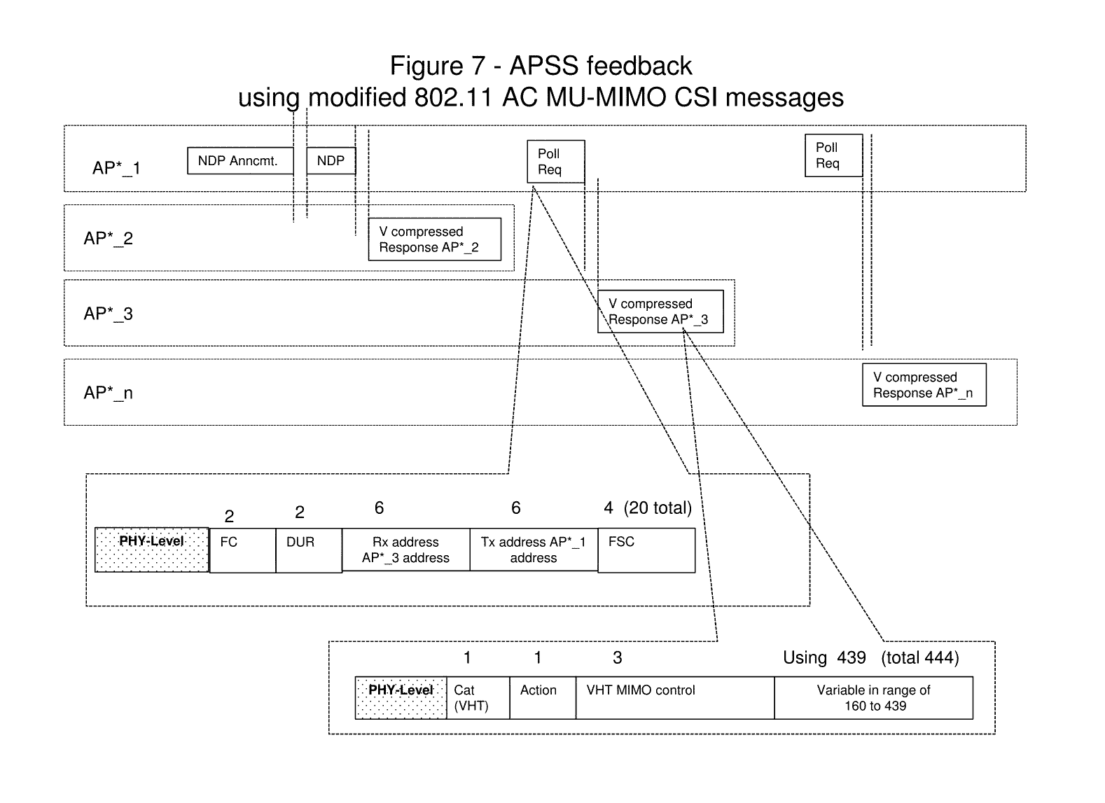

FIG. 6 shows a Null Data Packet (NDP) identical to what is used for 802.11ac. Assuming that AP*_1 is using a 40 MHz BW and has 4 antennas, the NDP duration would be 132 μsec (119 μsec for 400 nanosecond inter-symbol guard band). This is based on 802.11ac wireless LAN MAC and physical layer specifications, ref 9.31.5.2 Rules for VHT sounding protocol sequences. FIG. 7 illustrates a polling message from AP*_1, followed by V compressed responses from AP*_i according to embodiments of the invention. The AP*_1 polling message addressed to a specific AP*_i is 20 bytes long and may sent at MCS0 to assure that all AP*s detect the message, as with the NDP announcement frame, although other modulation coding schemes may be used. With PHY header the duration is 60 μsec (54 μsec for 400 nanosecond guard band). The V Compressed response is a very large packet, but of variable size depending on the resolution of the CSI data. An upper bound of message size is 444 bytes. This message is sent from AP*_i back to AP*_1 at MCS0 to assure reliable reception. According to some embodiments of this invention an attempt is made to null only the weaker AP*_i and therefore by definition the RSSI between AP*s for which nulling is attempted is near the CCA limit. Thus MCS0 may be chosen for reliable communication. With PHY header, the message duration is 358 μsec (322 μsec for 400 nanosecond inter-symbol guard band).

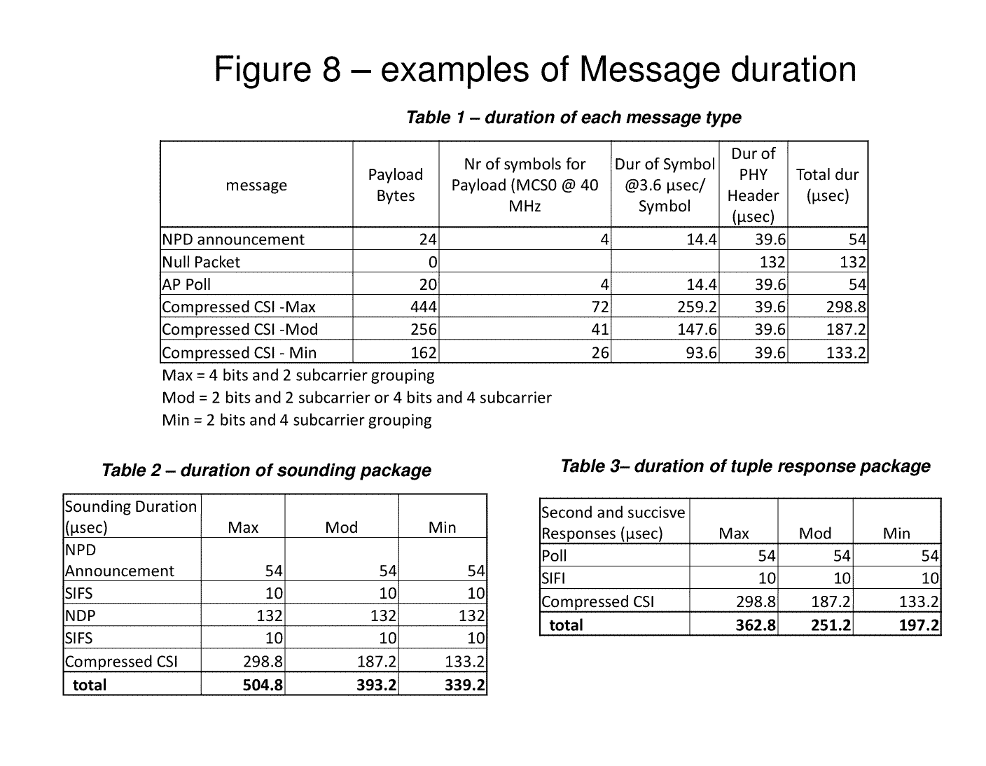

FIG. 8 summarizes examples of the durations of four sounding/feedback messages in the three tables, according to various embodiments of the invention. Table 1 shows the size of the messages, and the duration, in all cases with MCS0, in a 40 MHz bandwidth, with 400 nanosecond inter-symbol spacing. On the last line are shown 3 sizes of compressed CSI data. The compression algorithm used in these examples is the V compression as specified in 802.11ac in a 40 MHz channel, with 4 antennae. It will be appreciated that embodiments of the invention are not limited to a particular compression scheme. As stated in 802.11ac, 2 or 4 bits quantization can be used and 2 or 4 subcarrier grouping can be used. The size of the compressed message is directly affected by the choice of quantization used. FIG. 8, Table 2 shows the complete sounding processes according to embodiments of the invention. It is started by a sounding message package. The sounding package comprises a NDP announcement, an SIFS, a NDP message, another SIFS and the compressed CSI response from the first AP*. Three durations are listed, based on the quantization or compression size shown in Table 1 that was selected. FIG. 8, Table 3 shows several examples of complete response process according to embodiments of the invention for second and successive responses following the NDP. The response process in this example uses a tuple package comprising the AP Poll, an SIFS, and the Compressed CSI response. Table 3 has three durations, based on the quantization or compression size shown in Table 1 that was selected.

It will be appreciated from the foregoing that embodiments of the invention comprise sending respective sounding messages to multiple co-channel APs, receiving channel state information (CSI) from multiple co-channel APs in response to said sounding messages. The CSI information may be used to compile a table of CSI for said multiple co-channel APs. This may be separate from or integrated with the initialization table shown in FIG. 3 that is used in establishing an APSS.

Some embodiments of the invention include developing a sounding/CSI reporting schedule, for example according to according to the standard parameters discussed above, for multiple co-channel APs. One or more parameters applicable to such a schedule such as sounding rate, which may be referred to as sounding parameters, may be determined, for example based on any of the following constraints and others not listed below.
a. Sounding_overhead_max<Thresh_1 (typically 3.5%)
b. AP Maximum RSSI: Related to max null depth<=11 dB (typical)
c. V compression variables: bit per angle (1, 2, 3, 4) and subcarrier grouping (0, 2, 4)
d. CSI will be stable within limits over: 10, 50, 100, 200, 500 microsecond (estimated to change versus time of day and for each AP)
e. Probability of AP miss (this is probability that a specific AP will not process Sounding request) P_{AP miss}=˜15%

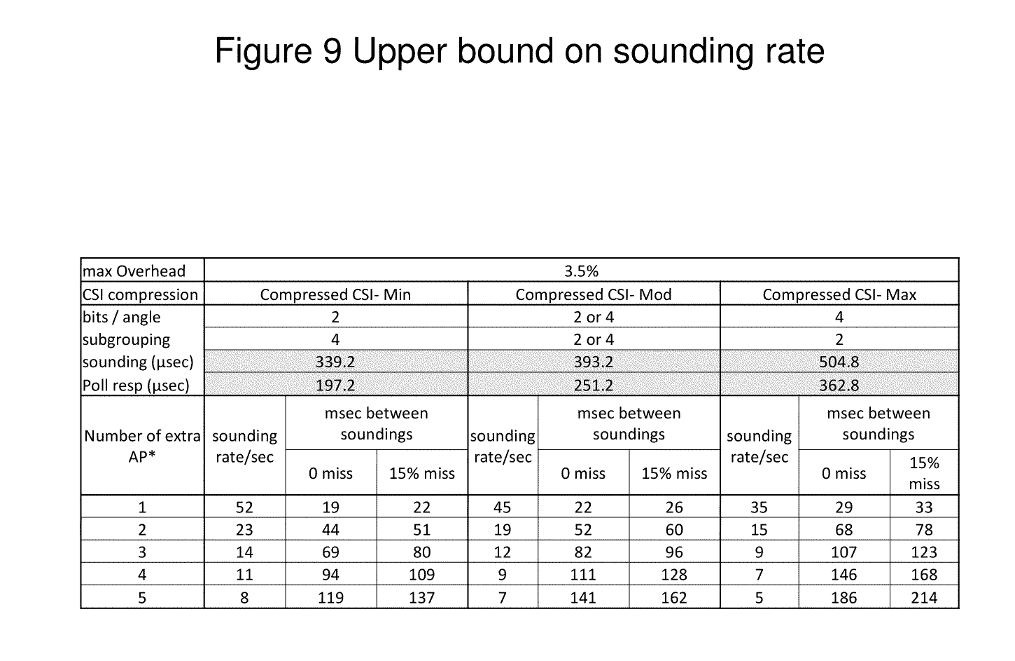

Using “trial” V compression, possible sounding rates, e.g. rates at which sounding messages are sent to AP*s, that meet these constraints are shown in the Table in FIG. 9. AP*_1 may sound at predetermined rate and when CCA indicates that the channel is clear it may collect successive CSI matrices from AP*_n, for example as part of a sounding sequence. Since most of the time budget is consumed in uploading the CSI data from the various AP*_n, this time is best used by directing the uploading to the least stable AP*_n, even to the extent of excluding some very unstable AP*_n from the process.

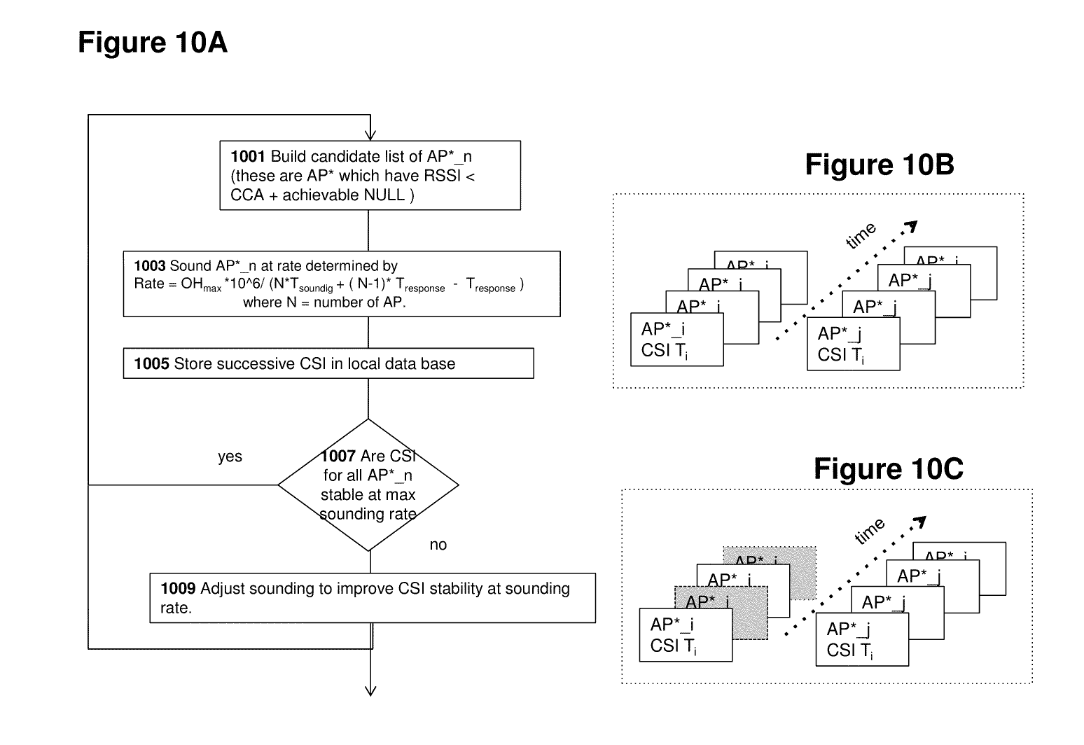

An example suitable Sounding Scheduling Algorithm (typical notational algorithm) or series of operations for adjusting sounding rate is illustrated in FIG. 10. This process may be implemented in one example as a computer algorithm, for example executed in the baseband processor of an AP* (and thus the baseband processor may be configured to carry out the process). An adjustment of the sounding rate may mean, for example, that some sounding sequences do not include a message addressed to a particular AP*_i because it is not necessary to update CSI for that AP*_i. If an AP* is omitted from a sounding sequence, it may be replaced by another for which CSI needs to be updated or by a UE.

In operation 1001, all AP*s with an RSSI below a predetermined threshold, for example RSSI>−82 dBm+11 dB, are removed from or not included in a sounding schedule or list as nulling will not be sufficient to allow simultaneous operation of the anchor AP with such an interfering AP. Thus in operation 1001 a candidate list may be compiled or created which includes only those APs that are candidates for nulling according to this criterion.

In operation 1003 an initial sounding rate is determined for all AP*_n. This may be achieved for example by first selecting “trial” V compression parameters: bit per angle=4 and subcarrier grouping=2 and using “trial” compression, selecting a sounding rate based on a maximum sounding rate. This maximum sounding rate may be based on for example one or more of:
number of AP*s
duration of sounding packet
duration of response packet
overhead
other parameters
   For example:

Sounding Rate=OHₘₐₓ*10̂6/(N*T_{sounding}+(N−1)*Tᵣₑₛₚₒₙₛₑ−Tᵣₑₛₚₒₙₛₑ) where OHmax is a predetermined maximum overhead percentage (e.g., 3.5%), N is number of APs in APSS, T_{sounding} and Tᵣₑₛₚₒₙₛₑ are durations of sounding packet and response packet in microseconds.

Successive CSI measurements may be stored in a local database or table as shown in operation 1005.

FIG. 10B shows successive CSI values, or uploads, for different AP*_n, AP*_i and AP*_j. If the number of AP*s (N) is low, the time between CSI uploads will be short and the CSI matrix may not change much. But if the value of N is high, then the time between CSI uploads will be longer and the CSI matrix may change by an unacceptable amount, e.g. CSI_{—Ti}-CSI_{—Ti-1} is more than a predetermined amount.

However even with longer intervals between CSI uploads, some AP*_n may not change much. This may enable AP*_1 to adjust how often it requests and uploads CSI from a specific AP*_n. FIG. 10C shows AP*_i CSI values being uploaded at half the rate of CSI values of AP*_j. The reduced upload of AP*_i means that AP*_1 can increase the sounding rate and CSI upload rate to other AP*_n, while staying within the 3.5% average utilization. This is an example of one degree of freedom afforded to AP*_1. According to another embodiment of the invention, AP*_1 can change the CSI resolution (bit rate, subchannel grouping), some AP*_n can be dropped, some AP*_n can be uploaded at ⅓ or even lower rates.

The characteristic of AP to AP channels is expected to fluctuate from very stable to very dynamic based on the specific deployment configuration and time of day issues. For example in a city situation cars driving by could affect channel characteristics. The process, e.g. algorithm, may run continuously, adjusting the sounding and CSI reporting schedule in response to these changes. Thus in operation 1007, a decision may be made as to whether the CSI values are stable at the sounding rate determined in operation 1003. If the determination is positive, the process is operating satisfactorily and the flow returns or iterates to operation 1001 without any modification of sounding rate. If the determination at operation 1007 is negative and the CSI is found to be unstable for any AP*_N, the sounding rate of one or more AP*_n is adjusted at operation 1009 before operation 1001 is repeated. Possibilities for adjusting sounding rate include, for example:
increasing a sounding rate for one or more co-channel APs for which the CSI is determined to be unstable,
decreasing a sounding rate for one or more co-channel APs for which the CSI is not determined to be unstable (which may then enable increasing a sounding rate for another AP)
ceasing to send sounding messages to one or more co-channel APs for which the CSI is determined to be unstable—e.g. dropping a very unstable AP*_n from CSI sounding.
   The foregoing examples refer to sounding rate. Another parameter that might be varied is compression rate, otherwise referred to as resolution. The determination at operation 1007 may include determining that CSI is stable for one or more AP*_n in which case it may be possible to increase the CSI compression rate, or lower CSI resolution, for AP*s with stable CSI. The compression rate may be requested by the AP* that sent the NDP, for example as part of a message addressed to an AP, such as the NDP announcement or a subsequent polling message.

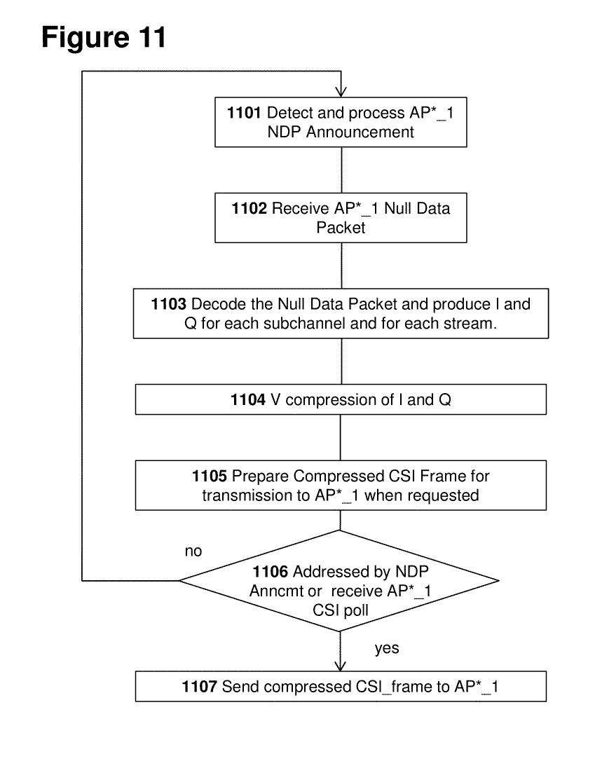

FIG. 11 shows an example of a process flow that may be implemented in an AP*_i, which is an AP other than the anchor AP* in an APSS. In operation 1101, AP*_i detects and processes an NDP announcement message. As part of the processing in operation 1101, the BSS ID in the NDP announcement is examined. At operation 1102, AP*_i detects or receives an NDP. When in operation 1101 AP*_i sees an NDP announcement with a BSS ID in its APSS table (see e.g. table 307 of FIG. 3), at operation 1103 it processes the NDP received at operation 1102, for example measuring parameters of the received NDP such as I and Q, e.g. on all subcarriers, to provide CSI to the anchor AP. The result may for example be 2 Bytes, 114 subcarriers and 16 jstreams=3648 Bytes, for each of I and Q. At operation 1104, in a process similar to the 802.11ac explicit sounding procedure, the CSI, e.g. I and Q values, may be compressed, for example by V-compression, e.g. conversion to polar coordinates and Givens. This may be done under the direction of the anchor AP*, e.g. AP*_1, for example in the NDP announcement. The AP may direct the other AP to further reduce the CSI data, for example by reduction of any of bits, angle and subchannel grouping. Three examples of reduction, or compression, are proposed in the foregoing. Embodiments of the invention are not limited to these suggestions for compression or reduction of data and others may be proposed.

The process of FIG. 11 assumes that an AP will be addressed in an NDP announcement, for example in the receive address indicated in FIG. 5, but as noted above it is also possible for an AP to be addressed in another sounding message or packet, such as a polling message transmitted after the NDP announcement has been addressed to a UE or other associated STA.

At operation 1105 the reduced CSI is prepared for compressed data for transmission. At operation 1106, it is determined whether the AP*_i was addressed in the NDP announcement or whether a poll addressed to that AP*_i is received. If no such poll is received and the AP*_i is not addressed in the announcement, operations 1101 to 1105 are repeated. When a CSI poll sent from AP*_1 and addressed to AP*_i is received or the AP*_i is addressed in the announcement, at operation 1107 AP*_i sends the CSI data. If a new sounding message, for example an NDP announcement, is received before data has been requested by AP*_1, the CSI matrix is overwritten, for example at operation 1103. It should be noted that an AP*_i maybe part of multiple APSS networks or sounding sets. For example in FIG. 2, AP*_2 could be part of an APSS sounding set of which AP*_1 is the anchor AP* and could also be part of a sounding set of which another AP* not shown is the anchor AP. Therefore according to embodiments of the invention, multiple CSI databases are be supported by AP*_i and AP*_i is able to recognize more than one APSS ID at operation 1101.

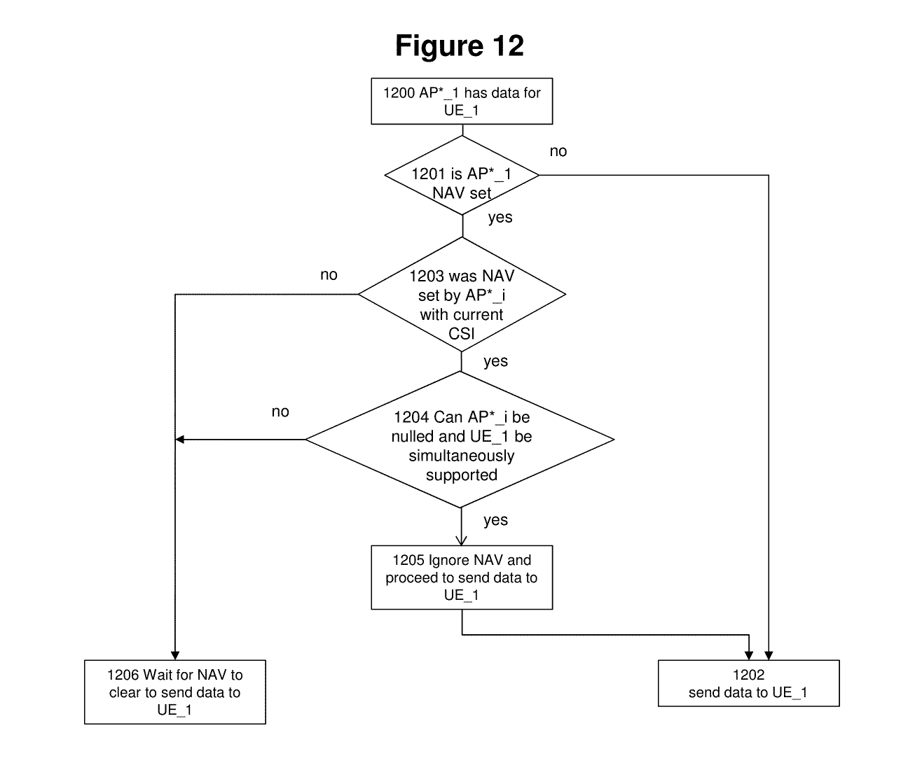

FIG. 12 shows an example of a possible process flow in AP*_1 for sending data to UE_1. The process begins with operation 1200 when AP*_1 has data to send to UE_1. When AP*_1 has data to send to UE_1, it checks at operation 1201 to see if the NAV is set. If not, AP*_1 proceeds to send data at operation 1202. However if NAV is set, then at operation 1203 AP*_1 determines whether the NAV was set by one of the AP*_i that is in the APSS set of AP*_1. If not, the process continues to operation 1206 in which AP*1 waits until the NAV is not set before attempting to send data to UE_1. If the NAV was set by one of the AP*_i that is in the APSS set of AP*_1, then also at operation 1203, AP*_1 determines whether the CSI data from APSS is current and if not the process continues to operation 1206. If the result of both determinations at operation 1203 is positive, with this current CSI data, at operation 1204 AP*_1 determines whether it can generate a null to AP*_i sufficient to protect it (below its CCA) and also support UE_1. If this condition can be met it has been determined that that the radiation pattern of the AP*_1 towards at least one co-channel AP*_i can be reduced sufficient to protect the AP from interference from the at least one co-channel neighboring AP. In that case AP*_1 may ignore the NAV being set, generate the radiation pattern, and proceed to send data to UE_1 at operation 1205. In other words, messages may be exchanged with a STA such as a UE at the same time as generating the reduced radiation pattern. If this condition is not met, then again it may wait till NAV clears at operation 1206. The foregoing assumes that only one AP* is active. However there might be two or more active AP*s in an APSS and it might be possible for AP*_1 to create multiple nulls. This might occur for example if one AP* is already nulling another active AP that has set the NAV.

According to embodiments of the invention, an AP may obtain explicit feedback from a co-channel AP as an extension of the standard procedure of obtaining CSI information from its associated UEs. In this manner the AP will have timely CSI information based on explicit feedback from the co-channel AP enabling it to develop a high quality null toward that AP. Embodiments of the invention may use a modification to the 802.11 addressing approach used by AP*_1 when sending the NDP announcement message. For example, AP*_1 may substitute AP*_2 in the field that would otherwise identify an associated STA such as a UE. Otherwise, the NDP announcement is the same. Consequently, the various STAs will see the message flows as standard. AP*_1 may receive CSI information from AP*_2 and each of its UEs that it polls in a manner similar to that proposed in the standard 802.11 MU_MIMO sounding procedure. After that AP*_1 generates a pattern as shown in FIG. 2.

In the example sounding sequences described above with reference to FIGS. 4A and 4B, associated STAs or possibly interfering APs are addressed in a sounding sequence. According to embodiments of the invention, both APs and UEs may be addressed in the same sounding sequence. Thus a sounding sequence may comprise an announcement message followed by messages transmitted from the AP and addressed respectively to said at least one associated STA and said at least one co-channel AP. Either the NDP announcement or a subsequent polling message may be addressed to an AP instead of an associated STA.

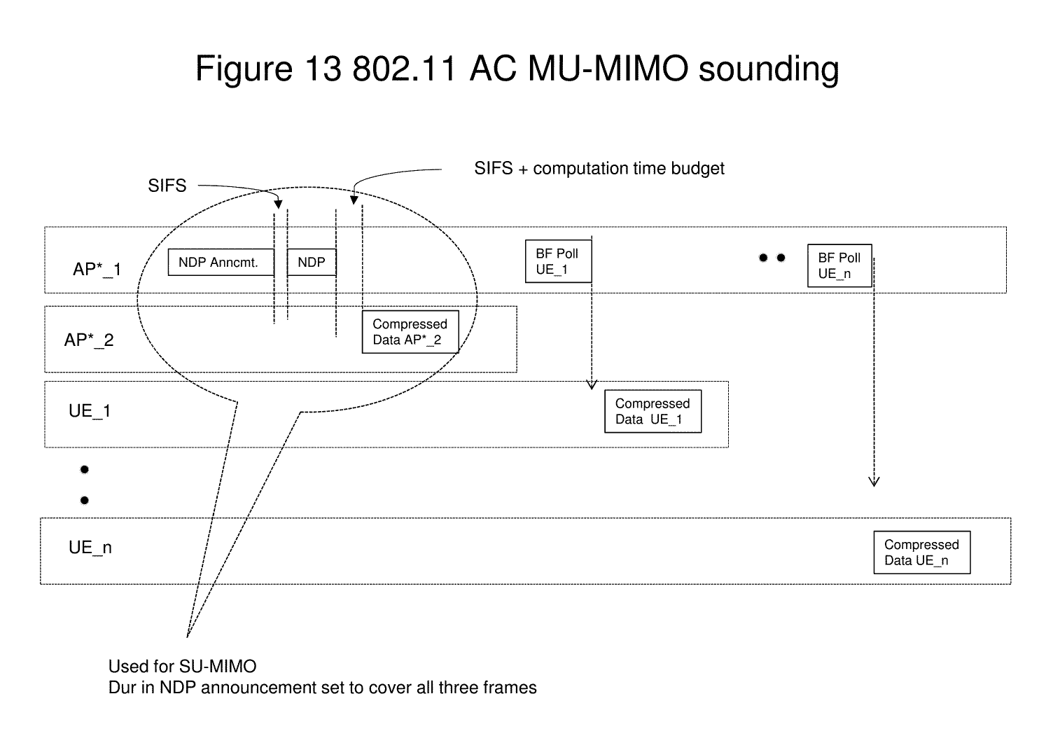

FIG. 13 shows an example of an 802.11 MU-MIMO sounding message flow, such as might be initiated by AP*_1, with sounding of AP*_2 added. The message sequence is identical to what was shown in FIG. 4A, except each successive STA is slipped to the right and the first CSI received following the NDP is from AP*_2. This change is transparent to the polled stations. They respond to polling messages in the same way as a station addressed in the NDP announcement responds following the NDP. As shown in FIG. 13, AP*_1 will receive AP*_2 CSI data as part of the original 3-message sequence of NDP announcement, NDP and reception of compressed data. Thus, an AP* using the message sequence of FIG. 13, under the control of its baseband processor, may monitor at least one associated STA and at least one other AP* and send a message to each via the radio circuitry as part of a sounding sequence implemented by the baseband processor. The message sequence may include the NDP announcement followed by messages such as the NDP and subsequent polling messages, the announcement and polling messages being addressed respectively to at least one other AP* and at least one associated STA.

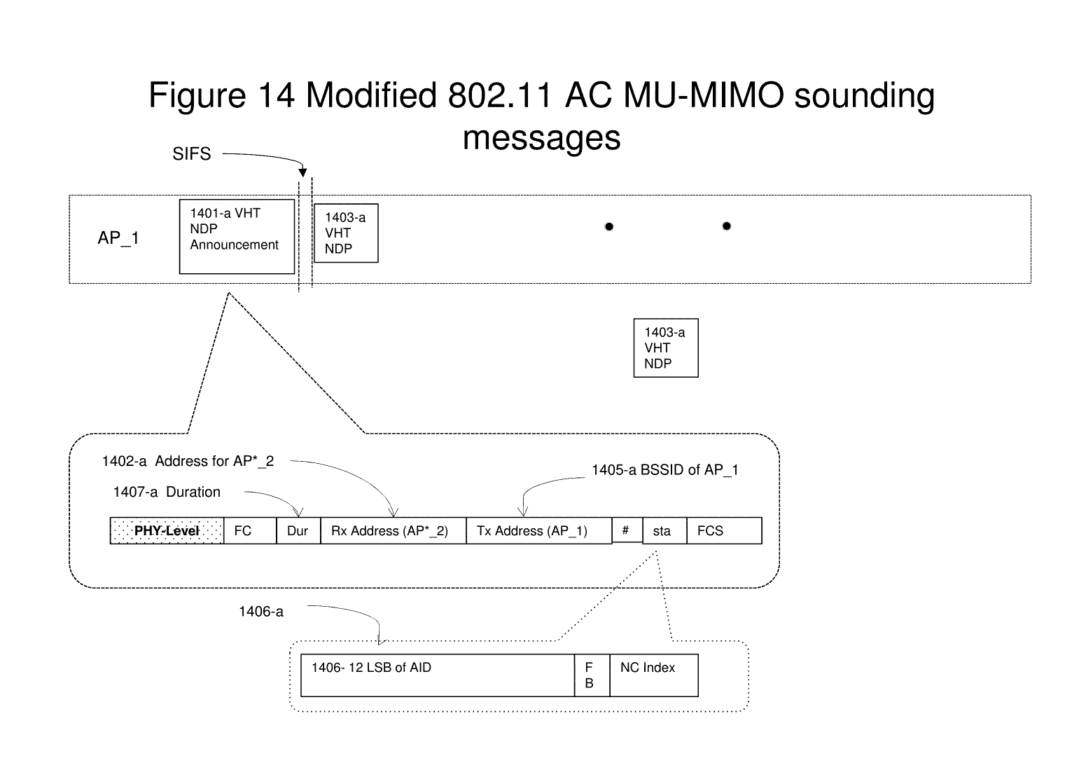

This may be accomplished transparently to the other stations as shown in FIG. 14 by substituting AP*_2 as the Rx_address in the NDP announcement message, thereby causing AP*_2 to immediately return CSI data without being polled, just as described in the standard MU-MIMO protocol for an associated STA. In other words, the sounding flow may be the same as that shown in FIG. 5 in which an AP* is addressed in the address field 502 but the sta field may include the UE association ID, as it is presently proposed in the 802.11 standard. AP*_1 may set the “Dur” field in the NDP announcement message to protect or included the entire exchange—NDP announcement, NDP and reception of compressed data. Thus AP*_1 is configured to provide time to receive data of a predetermined duration prior to sending another sounding message, such as a polling message. It is possible that AP*_2 will not respond to the NDP announcement because of any of several reasons, including being occupied with a UE that was “hidden” from AP*_1. If AP*_1 detects that AP*_2 is not responding as expected, for example within a time which is shorter than the predetermined duration of the received data, AP*_1 can override the “Dur” value, that it set, and proceed to poll the first UE for its CSI feedback before the expiry of the duration. In other words, channel time will not be wasted if AP*_2 is not responsive. AP*_1 uses the CSI data it receives to generate its antenna patterns. If it did not receive CSI data from AP*_2 it can either not attempt to null AP*_2 or use other lower quality CSI data (older or implicitly derived CSI data), however those decisions are not part of this invention.

It should be noted that where both associated STAs and possibly interfering AP*s are addressed in the same sounding sequence, it is not necessary for an AP* to be addressed in the first addressed message, the NDP announcement. It is also possible for an AP* to be polled at some later stage in the sequence, for example after an NDP announcement has been addressed to a UE. Thus, to take the example polling sequence shown in FIG. 4A, any of the polled UEs could be replaced with an AP.

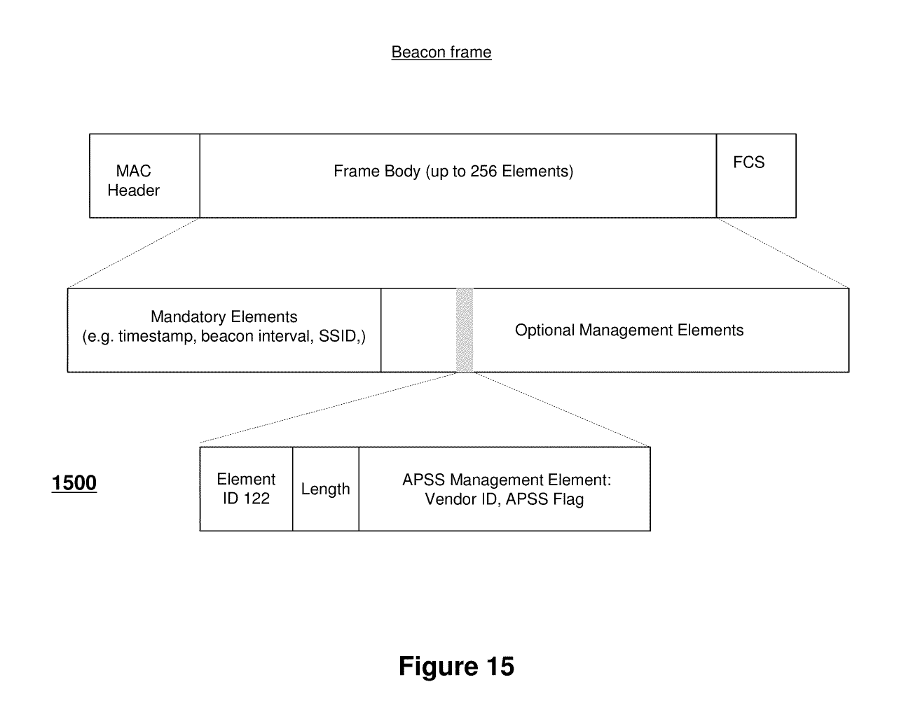

As noted above, an AP may be configured to indicate that it is capable of responding to sounding packets by transmitting identification of this capability, for example in its beacon transmission, e.g. beacon frame. FIG. 15 is a diagram illustrating the structure of the 802.11 beacon Frame 1500 in accordance with embodiments of the present invention. This frame is transmitted by all 801.11 APs at a periodic rate, typically 10 times per second. This beacon includes mandatory information such as the SSID of the AP but can optionally include other information, e.g. vendor specific data. According to embodiments of the invention, the vendor specific data may start with a device/vendor ID followed by a flag to indicate AP to AP CSI feedback capability. Where this becomes standardized, a specific Information Element ID could be assigned to indicate this capability rather than embedding this information in a vendor specific data element.

While certain utilizations, rates, numbers of components or antennas, data lengths or data formats, coverage areas, etc. are discussed herein, other specific values or numbers may be used in other embodiments.

The methods described for embodiments of this invention can be implemented in hardware, a combination of hardware and software or software only. A unique aspect of some embodiments is the possibility for implementation completely in software, for example by augmenting the notational algorithms of the 802.11 xx protocol. Thus embodiments of the invention may take the form of one or more computer readable media, e.g. non-transitory computer readable media, which when implemented on one or more processors in an AP system to perform any of the methods described above.

The methods described herein are applicable to all versions of the 802.11 protocol, specifically 802.11 a, b, g, n and ac.

As will be appreciated by someone skilled in the art, aspects of the present invention may be embodied as a system, method or an apparatus. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” In one aspect the invention provides a computer readable medium comprising instructions which when implemented on one or more processors in a computing system causes the system to carry out any of the methods described above. The computer readable medium may be in non-transitory form.

The aforementioned block diagrams illustrate the architecture, functionality, and operation of possible implementations of systems and methods according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples. It is to be understood that the details set forth herein do not construe a limitation to an application of the invention. Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers. If the specification or claims refer to “an additional” element, that does not preclude there being more than one of the additional element. It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks. The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only. Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein. While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. An access point (AP) configured to exchange messages with at least one associated station (STA) via a wireless channel, the AP comprising:
a plurality of antennas;
radio circuitry configured to transmit and receive signals via said antennas; and
a baseband processor;
wherein the baseband processor is configured to monitor signals received by the radio circuitry from said at least one associated STA and at least one co-channel AP and to send a single sounding message to both of said at least one associated STA and said at least one co-channel AP together via the radio circuitry as part of a sounding sequence implemented by the baseband processor.

2. The AP of claim 1 wherein said at least one co-channel AP is located within a clear channel assessment (CCA) range of the AP.

3. The AP of claim 1 wherein the sounding sequence comprises an announcement message transmitted from the AP followed by messages transmitted from the AP, wherein the announcement and following messages are addressed respectively to said at least one associated STA and said at least one co-channel AP.

4. The AP of claim 1 wherein the sounding message sequence comprises an announcement message transmitted from the AP followed by a null data packet (NDP) and the baseband processor is configured to address the announcement message to said at least one co-channel AP.

5. The AP of claim 1 wherein the sounding message sequence is according to an IEEE 802.11 standard and wherein the baseband processor is configured to address at least one of the messages, intended for a STA according to the standard, to said at least one AP.

6. The AP of claim 5 wherein said at least one of the messages is the null data packet (NDP) announcement.

7. The AP of claim 5 wherein said at least one of the messages is a polling message.

8. A method implemented in an access point (AP) configured to exchange messages with at least one associated station (STA) via a wireless channel, the AP comprising: a plurality of antennas, radio circuitry configured to transmit and receive via said antennas, and a baseband processor, the method comprising:
monitoring signals received by the radio circuitry from said at least one associated STA and at least one co-channel AP;
sending a single sounding message to both of said at least one associated STA and said at least one co-channel AP together via the radio circuitry as part of a sounding sequence implemented by the baseband processor; and
receiving channel state information (CSI) from said at least one co-channel AP in response to said message.

9. The method of claim 8 comprising sending respective sounding messages to multiple co-channel APs, receiving channel state information (CSI) from multiple co-channel APs in response to said sounding messages and compiling a table of CSI for said multiple co-channel APs.

10. The method of claim 9 in which one or more sounding parameters are determined on the basis of a maximum sounding overhead.

11. The method of claim 10 in which the one or more sounding parameters comprise rate of sounding said at least one co-channel AP.

12. The method of claim 9 in which said sounding messages are sent repeatedly, the method further comprising determining an initial sounding rate for sending said sounding messages to said multiple co-channel APs, determining that the CSI is unstable for one or more of said co-channel APs and adjusting one or more sounding parameters.

13. The method of claim 12 wherein adjusting comprises one or more of:
increasing a sounding rate for one or more co-channel APs for which the CSI is determined to be unstable,
decreasing a sounding rate for one or more co-channel APs for which the CSI is not determined to be unstable,
ceasing to send sounding messages to one or more co-channel APs for which the CSI is determined to be unstable.

14. The method of claim 9 in which said sounding messages are sent repeatedly, the method further comprising determining an initial sounding rate for sending said sounding messages to said multiple co-channel APs, determining a compression rate for CSI transmitted by said multiple co-channel APs, determining that the received CSI is stable for one or more of said co-channel APs and for one or more of those APs with stable CSI increasing the CSI compression.

15. The method of claim 8 comprising determining that the radiation pattern of the AP towards said at least one co-channel AP can be reduced sufficiently to protect the AP from interference from the at least one co-channel neighboring AP; and generating a radiation pattern that is reduced towards said at least one co-channel AP.

16. The method according to claim 15 further comprising exchanging messages with at least one associated station (STA) via a wireless channel at the same time as generating said reduced radiation pattern.

17. The method according to claim 16 comprising, prior to said determining, generating and exchanging, determining that a network allocation vector (NAV) for the channel is set.

18. The method according to claim 16 comprising prior to said determining, generating and exchanging, determining that the NAV has been set by one said co-channel neighboring AP.

19. An access point (AP) configured to exchange messages with at least one associated station (STA) via a wireless channel, the AP comprising:
a plurality of antennas;
radio circuitry configured to transmit and receive via said antennas and
a baseband processor,
wherein the baseband processor is configured to transmit identification of capability of the AP to respond to sounding packets in a beacon frame of the AP, and to detect a sounding packet addressed to it sent by a co-channel AP over the wireless channel, and to send channel state information (CSI) to said at least one co-channel AP via the wireless channel.

20. (canceled)

21. (canceled)
